(19) United States
(12) Patent Application Publication
(10) Pub. No.: US 2017/0043458 A1
(43) Pub. Date: Feb. 16, 2017

(54) PNEUMATIC TOOL MOTOR HAVING AN INTERNAL HAMMERING DEVICE

(71) Applicant: Ching-Shun CHANG, Taichung City (TW)

(72) Inventor: Ching-Shun CHANG, Taichung City (TW)

(73) Assignee: Hsiu-Ju Chen, Taichung City (TW)

(21) Appl. No.: 15/202,101

(22) Filed: Jul. 5, 2016

(30) Foreign Application Priority Data
Aug. 13, 2015 (TW) 104126365

(51) Int. Cl. B25B 21/02; F15B 15/08; F01B 23/06

(52) U.S. Cl. CPC B25B 21/02; F01B 23/06; F15B 15/08

(57) ABSTRACT

A pneumatic tool motor includes a cylinder, a rotor set, an output shaft and an internal hammering device received in a roller cylinder of the rotor set. A front cover and a rear cover respectively mounted on two opposite ends of the roller cylinder, wherein a front bearing and a rear bearing are respectively disposed in the front cover and the rear cover. The roller cylinder has two opposite ends respectively connected to the first bearing and the second bearing and the two opposite ends of the roller cylinder respectively abut against the front cover and the rear cover. Consequently, the roller cylinder does not needs to form any terminal structures on its two opposite ends for simplifying structure, reducing manufacturing cost and narrowing volume.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to pneumatic tool motor, and more particularly to a pneumatic tool motor having an internal hammering device.

2. Description of Related Art Including Information Disclosed Under 37 CFR 1.97 and 37 CFR 1.98.

A pneumatic tool, such as a pneumatic wrench, is provided for driving a large nut or bolt because the large nut or bolt needs a high torque such that the pneumatic tool must provide torque. Consequently, the pneumatic tool usually includes a hammering device disposed therein for formed the necessary torque. The hammering device usually includes two hammering blocks positioned and received in a block seat. The two hammering blocks are reciprocally stopped for forming inertia with a shaft and providing high torque.

For assembling the conventional hammering device, the pneumatic tool includes a housing disposed on a front end thereof for receiving the block seat, the hammering blocks and the supporting rods. However, the hammering device is disposed on the front end of the conventional pneumatic tool such that the axial length and the volume of the conventional pneumatic tool are raised. As a result, the distance between output end and the handle of the conventional pneumatic tool is lengthened such that the conventional pneumatic tool is inconvenient to operate. For the manufacturers, the longer and greater conventional pneumatic tool takes a lot of cost for preparing material, manufacturing, assembling and packaging. It is uneconomic to the manufacturers.

As to the rotor set of the conventional pneumatic tool, a roller cylinder includes a front panel and a rear panel that are independent parts such that the bolts are necessary for mounting the front panel and the rear panel. Consequently, the manufacturing processes of the conventional pneumatic tool are complex and assembling a pneumatic tool has a large volume.

The present invention has arisen to mitigate and/or obviate the disadvantages of the conventional pneumatic tool.

### BRIEF SUMMARY OF THE INVENTION

The main objective of the present invention is to provide an improved pneumatic tool motor that includes an internal hammering device.

To achieve the objective, the pneumatic tool motor in accordance with the present invention comprises a cylinder including a chamber defined in the cylinder, wherein a front cover and a rear cover are respectively mounted onto a front end and a rear end of the cylinder. A front bearing and a rear bearing are respectively disposed on the front cover and the rear cover. A rotor set is rotatably received in the chamber. The rotor set includes a roller cylinder and multiple blades radially partially inserted into the roller cylinder, wherein the roller cylinder has a front end rotatably coupled with the front bearing and a rear end rotatably coupled with the rear bearing and the blades abut against an inner periphery of the chamber. An inner chamber is defined in the roller cylinder of the rotor set. An output shaft extends through the roller cylinder. The output shaft is sequentially divided into a driven section, a middle section and a drive section. The driven section is secured in the rear cover, the drive section extends through the front cover and the middle section corresponds to the inner chamber in the roller cylinder. An internal hammering device is disposed in the inner chamber in the roller cylinder of the rotor set. The internal hammering device includes at least one hammering block formed on the middle section of the output shaft, at least one active hammer peripherally corresponding to the at least one hammering block and at least one supporting rod longitudinally positioned in the roller cylinder for supporting the at least one active hammer, wherein the front end of the roller cylinder of the rotor set abuts against the front cover of the cylinder and the rear end of the roller cylinder of the rotor set abuts against the rear cover of the cylinder.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is an exploded perspective view of a pneumatic tool, wherein the pneumatic tool motor in accordance with the present invention is mounted therein.

FIG. 2 is an exploded perspective view of a pneumatic tool motor in accordance with the present invention.

FIG. 3 is a front cross-sectional view of the pneumatic tool motor in accordance with the present invention.

FIG. 4 is a cross-sectional view of the pneumatic tool motor along line B-B in FIG. 3.

FIG. 5 is a cross-sectional view of the pneumatic tool motor along line C-C in FIG. 3.

FIG. 6 is a side cross-sectional of a second embodiment of the pneumatic tool motor in accordance with the present invention.

FIG. 7 is a side cross-sectional of a third embodiment of the pneumatic tool motor in accordance with the present invention.

FIG. 8 is an enlarged plan view of FIG. 7.

FIG. 9 is a side cross-sectional of a fourth embodiment of the pneumatic tool motor in accordance with the present invention.

FIG. 10 is a cross-sectional view of the pneumatic tool motor along line D-D in FIG. 9.

### DETAILED DESCRIPTION OF THE INVENTION

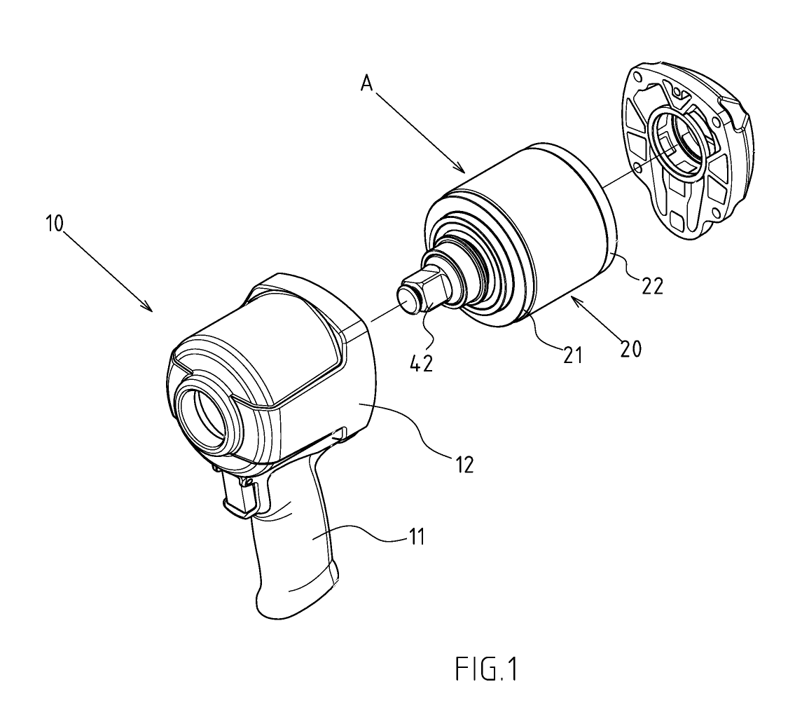

With reference to FIG. 1, a pneumatic tool 10 usually includes a handle 11 formed with a hollow body 12 and a pneumatic tool motor A in accordance with the present invention is received in the hollow body 12. Referring to the drawings and initially to FIGS. 1-4, the pneumatic tool motor A in accordance with the present invention comprises a cylinder 20 including a chamber 23 defined in the cylinder 20, wherein a front cover 21 and a rear cover 22 are respectively mounted onto a front end and a rear end of the cylinder 20. A front bearing 215 and a rear bearing 225 are respectively disposed on the front cover 21 and the rear cover 22. A rotor set 30 is rotatably received in the chamber 23. The rotor set 30 includes a roller cylinder 31 and multiple blades 32 radially partially inserted into the roller cylinder 31, wherein the roller cylinder 31 has a front end rotatably coupled with the front bearing 215 and a rear end rotatably coupled with the rear bearing 225 and the blades 32 abut against an inner periphery of the chamber 23. An inner chamber 33 is defined in the roller cylinder 31 of the rotor set 30. An output shaft 40 extends through the roller cylinder 31. The output shaft 40 is sequentially divided into a driven section 41, a middle section 43 and a drive section 42. The driven section 41 is secured in the rear cover 22, the drive section 42 extends through the front cover 21 and the middle section 43 corresponds to the inner chamber 33 in the roller cylinder 31. An internal hammering device 50 is disposed in the inner chamber 33 in the roller cylinder 31 of the rotor set 30. The internal hammering device 50 includes at least one hammering block 51 formed on the middle section 43 of the output shaft 40, at least one active hammer 52 peripherally corresponding to the at least one hammering block 51 and at least one supporting rod 53 longitudinally positioned in the roller cylinder 31 for supporting the at least one active hammer 52, wherein the front end of the roller cylinder 31 of the rotor set 30 abuts against the front cover 21 of the cylinder 20 and the rear end of the roller cylinder 31 of the rotor set 30 abuts against the rear cover 22 of the cylinder 20.

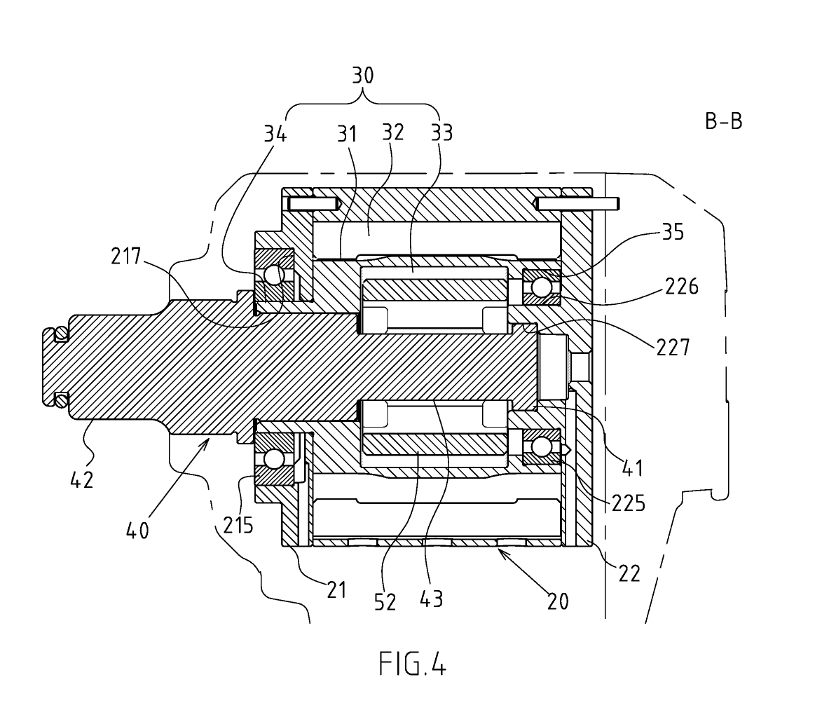

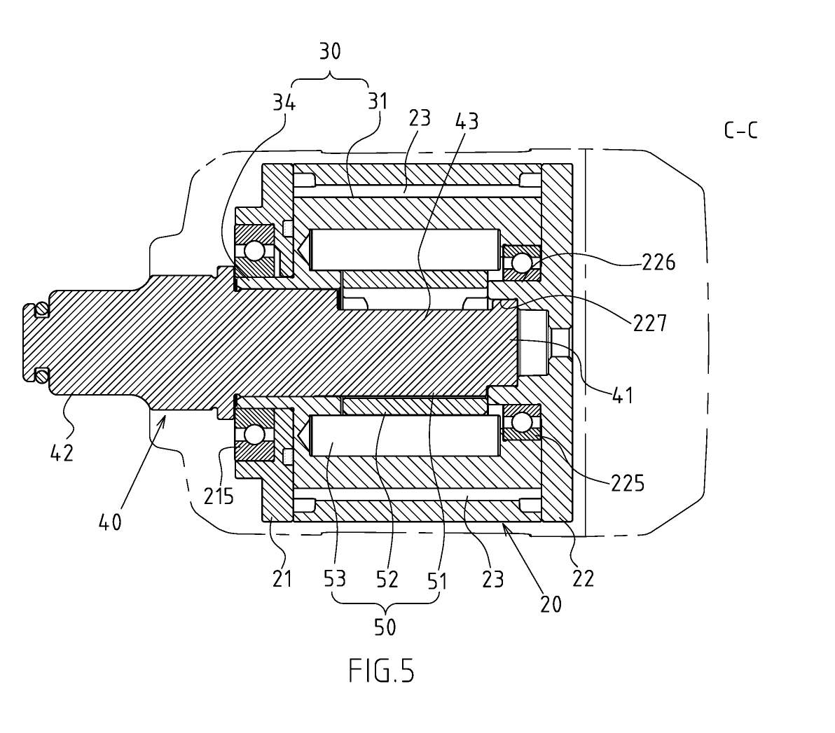

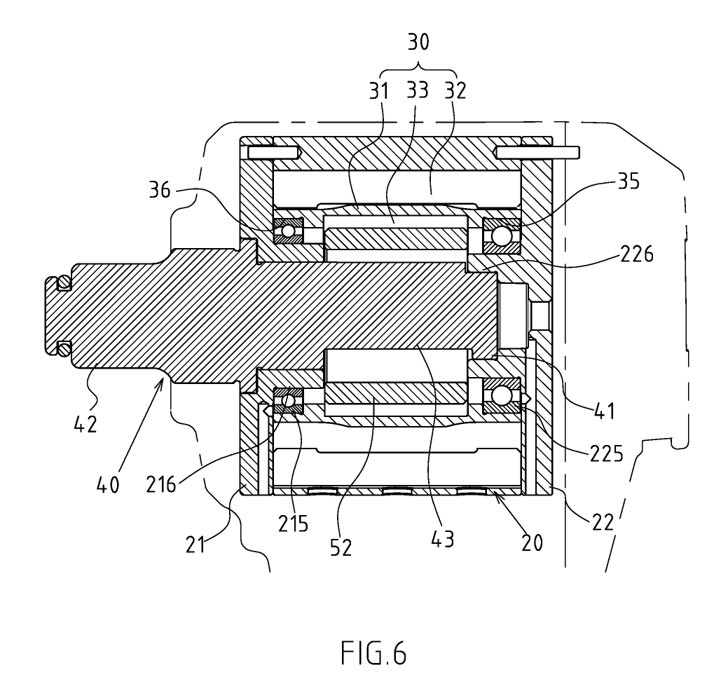

At least one of the front cover 21 and the rear cover 22 has a tubular structure 216/226 centrally extending into the roller cylinder 31 of the rotor set 30 for mounting the front bearing 215/the rear bearing 225 between the tubular structure 216/226 and an inner periphery of the roller cylinder 31 of the rotor set 30. With reference to FIG. 4, in the preferred embodiment of the present invention, only the rear cover 22 of the cylinder 20 has a tubular structure 226 centrally extending therefrom and extending into the roller cylinder 31 of the rotor set 30. With reference to FIG. 6, in the preferred embodiment, the front cover 21 and the rear cover 22 respectively includes a tubular structure 216/226 centrally extending therefrom.

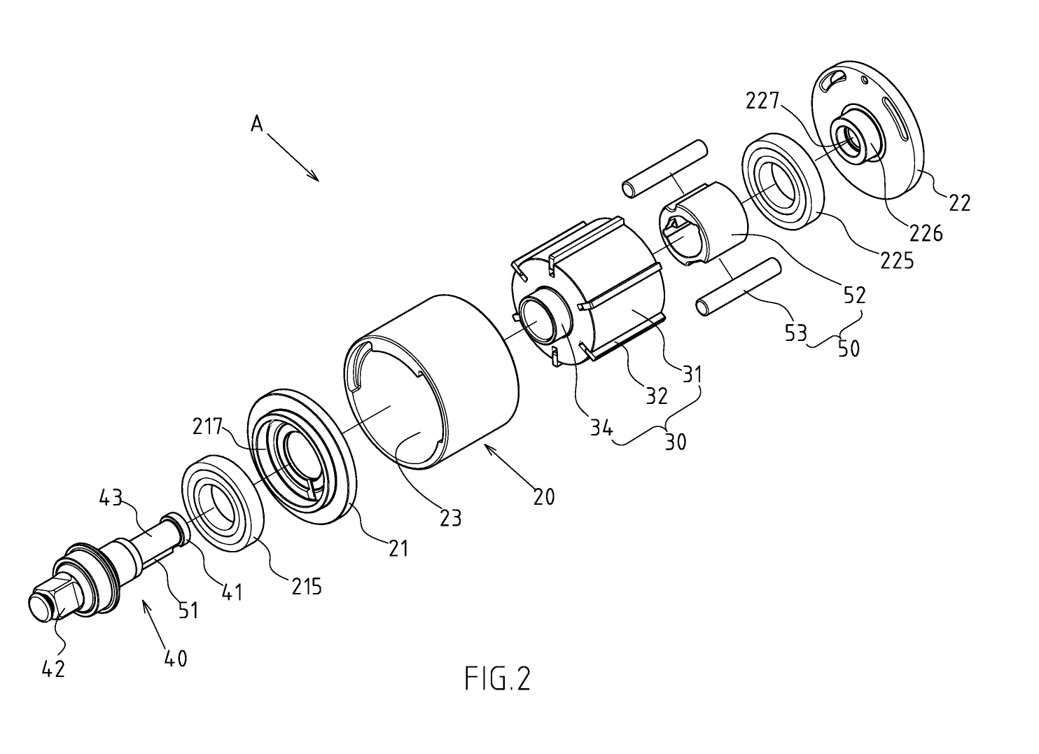

With reference to FIGS. 2 and 4, the rear cover 22 of the cylinder 20 has a hole 227 defined in the tubular structure 226 for securely receiving the driver section 41 of the output shaft 40.

With reference to FIG. 4, only the rear cover 22 of the cylinder 20 has a tubular structure 226 centrally extending therefrom and extending into a rear end of the roller cylinder 31 of the rotor set 30. The roller cylinder 31 includes a skirt 34 extending from a front end thereof and a recess 217 is defined in the front cover 21 of the cylinder 20 for securely receiving the front bearing 215, wherein the skirt 34 on the front end of the roller cylinder 31 is inserted into the front bearing 215.

With reference to FIG. 4, a rear annular groove 35 is defined in the rear end of the roller cylinder 31 for securely receiving the rear bearing 225.

With reference to FIG. 6, the front cover 21 and the rear cover 22 of the cylinder 20 respectively includes a tubular structure 216, 226 extending therefrom and extending into the roller cylinder 31 of the rotor set 30. The front bearing 215 is securely positioned between the tubular structure 216 of the front cover 21 and an inner periphery of the front end of the roller cylinder 31 of the rotor set 30, and the rear bearing 225 is securely positioned between the tubular structure 226 of the rear cover 22 and an inner periphery of the rear end of the roller cylinder 31 of the rotor set 30.

As the preferred embodiment in FIG. 6, a rear annular groove 35 is defined in an inner periphery of the rear end of the roller cylinder 31 for securely receiving the rear bearing 225 and a front annular groove 36 is defined in an inner periphery of the front end of the roller cylinder 31 for securely receiving the front bearing 215.

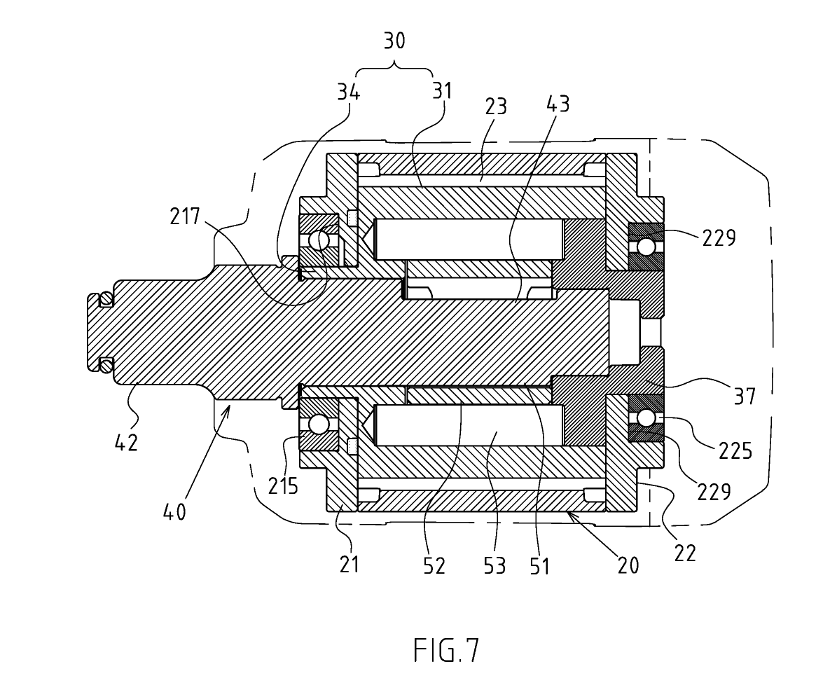

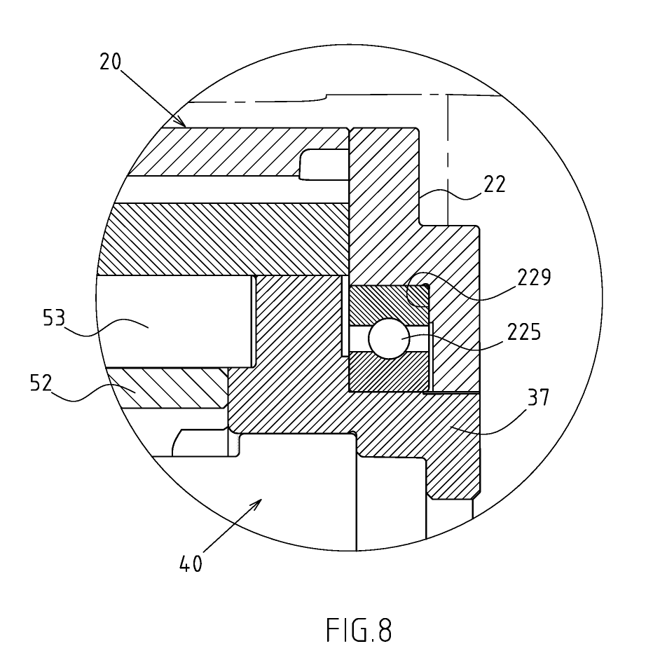

With reference to FIG. 7, the roller cylinder 31 includes a skirt 34 extending from the front end thereof and the front cover 21 of the cylinder 20 has a recess 217 defined therein, wherein the front bearing 215 is securely received in the recess 217 and securely sleeved on the skirt 34. The rotor set 30 includes a collar 37 is mounted into the rear end of the roller cylinder 31 and extending through the rear cover 22. The rear cover 22 of the cylinder 20 has an annular groove 229 defined in a rear face thereof, wherein the rear bearing 225 is securely received in the annular groove 229 and securely sleeved on the collar 37. With reference to FIG. 8, the rear cover 22 of the cylinder 20 has an annular groove 229 defined in a front face thereof, wherein the rear bearing 225 is securely received in the annular groove 229 and securely sleeved on the collar 37.

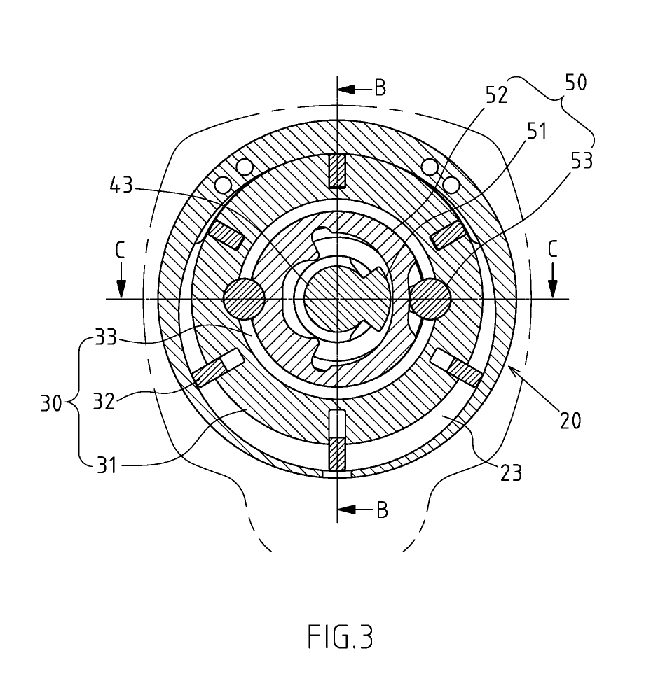

With reference to FIG. 3, each blade 32 is radially reciprocally moved relative to the roller cylinder 31 such that the edge of each the blades 32 abuts against the inner periphery of the chamber 23.

The air paths in the internal hammering device 50 and the operation mode of the internal hammering device 50 are conventional and not repeated, hereinafter. The two opposite ends of the roller cylinder 31 respectively abut against the front cover 21 and the rear cover 22 of the cylinder 20 such that the front panel and the rear panel of the conventional pneumatic tool motor are unnecessary to the pneumatic tool motor in accordance with the present invention. As a result, the structures of the pneumatic tool motor in accordance with the present invention are greatly simplified.

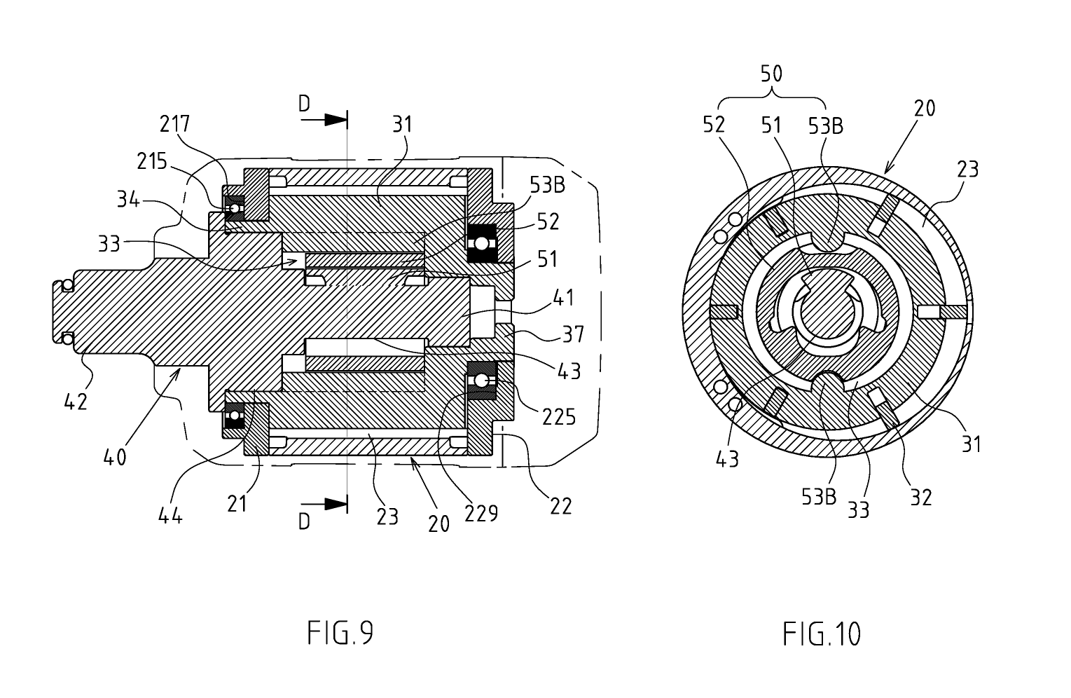

With reference to FIGS. 9 and 10, an inside diameter of the skirt 34 is not less than that of the inner chamber 33 in the roller cylinder 31. In addition, the output shaft 40 is formed with an enlarged section 44 rotatably received in the skirt 34. The supporting rod 53B is integrally formed with the inner periphery of the roller cylinder 31 for supporting the active hammer 52.

As described above, at least one of the front cover 21 and the rear cover 22 has a tubular structure 216/226 centrally extending into the roller cylinder 31 of the rotor set 30 for mounting the front bearing 215/the rear bearing 225 between the tubular structure 216/226 and an inner periphery of the roller cylinder 31 of the rotor set 30. Consequently, the front panel and the rear panel of the conventional pneumatic tool motor are unnecessary to the pneumatic tool motor in accordance with the present invention and the structures of the pneumatic tool motor in accordance with the present invention are greatly simplified.

Although the invention has been explained in relation to its preferred embodiment, it is to be understood that many other possible modifications and variations can be made without departing from the spirit and scope of the invention as hereinafter claimed.

I claim:

1. A pneumatic tool motor comprising:
a cylinder including a chamber defined therein, a front cover and a rear cover respectively mounted onto a front end and a rear end of the cylinder, a front bearing and a rear bearing respectively disposed on the front cover and the rear cover;
a rotor set rotatably received in the chamber, the rotor set including a roller cylinder and multiple blades radially partially inserted into the roller cylinder, wherein the roller cylinder has a front end rotatably coupled with the front bearing and a rear end rotatably coupled with the rear bearing and the blades abut against an inner periphery of the chamber;
an inner chamber defined in the roller cylinder of the rotor set;
an output shaft extending through the roller cylinder, the output shaft sequentially divided into a driven section, a middle section and a drive section, the driven section secured in the rear cover, the drive section extending through the front cover and the middle section corresponding to the inner chamber in the roller cylinder;
an internal hammering device disposed in the inner chamber in the roller cylinder of the rotor set, the internal hammering device including at least one hammering block formed on the middle section of the output shaft, at least one active hammer peripherally corresponding to the at least one hammering block and at least one supporting rod longitudinally positioned in the roller cylinder for supporting the at least one active hammer, wherein the front end of the roller cylinder of the rotor set abuts against the front cover of the cylinder and the rear end of the roller cylinder of the rotor set abuts against the rear cover of the cylinder.

2. The pneumatic tool motor as claimed in claim 1, wherein at least one of the front cover and the rear cover has a tubular structure centrally extending into the roller cylinder of the rotor set for mounting the front bearing/the rear bearing between the tubular structure and an inner periphery of the roller cylinder of the rotor set.

3. The pneumatic tool motor as claimed in claim 2, wherein the rear cover of the cylinder has a hole defined in the tubular structure for securely receiving the driver section of the output shaft.

4. The pneumatic tool motor as claimed in claim 3, wherein only the rear cover of the cylinder has a tubular structure centrally extending therefrom and extending into a rear end of the roller cylinder of the rotor set, the roller cylinder including a skirt extending from a front end thereof and a recess defined in the front cover of the cylinder for securely receiving the front bearing, wherein the skirt on the front end of the roller cylinder is inserted into the front bearing.

5. The pneumatic tool motor as claimed in claim 4, wherein rotor set includes a rear annular groove defined in the rear end of the roller cylinder for securely receiving the rear bearing.

6. The pneumatic tool motor as claimed in claim 2, wherein the front cover and the rear cover of the cylinder respectively includes a tubular structure extending therefrom and extending into the roller cylinder of the rotor set, the front bearing securely positioned between the tubular structure of the front cover and an inner periphery of the front end of the roller cylinder of the rotor set, and the rear bearing securely positioned between the tubular structure of the rear cover and an inner periphery of the rear end of the roller cylinder of the rotor set.

7. The pneumatic tool motor as claimed in claim 6, wherein a rear annular groove is defined in an inner periphery of the rear end of the roller cylinder for securely receiving the rear bearing and a front annular groove is defined in an inner periphery of the front end of the roller cylinder for securely receiving the front bearing.

8. The pneumatic tool motor as claimed in claim 2, wherein the roller cylinder includes a skirt extending from the front end thereof and the front cover of the cylinder has a recess defined therein, and wherein the front bearing is securely received in the recess and securely sleeved on the skirt; the rotor set including a collar mounted into the rear end of the roller cylinder and extending through the rear cover, the rear cover of the cylinder having an annular groove defined in a rear face thereof, wherein the rear bearing is securely received in the annular groove and securely sleeved on the collar.

9. The pneumatic tool motor as claimed in claim 8, wherein an inside diameter of the skirt is not less than that of the inner chamber in the roller cylinder and the output shaft is formed with an enlarged section rotatably received in the skirt.

10. The pneumatic tool motor as claimed in claim 9, wherein the supporting rod is integrally formed with the inner periphery of the roller cylinder for supporting the active hammer.
